(19) United States
(12) Patent Application Publication
(10) Pub. No.: US 2011/0216697 A1
(43) Pub. Date: Sep. 8, 2011

(54) WIRELESS NETWORK SYSTEM AND RELATED WIRELESS ROUTING CIRCUIT

(76) Inventors: Chung-Chiu LAI, Zhubei City (TW); Ling-Chun CHEN, Hsinchu City (TW); Wei-Tsan WANG, Zhongpu Township (TW)

(21) Appl. No.: 12/765,683

(22) Filed: Apr. 22, 2010

(30) Foreign Application Priority Data
Mar. 4, 2010 (TW) 099106325

(51) Int. Cl. H04W 4/00; H04L 12/56

(52) U.S. Cl. 370/328; 370/401

(57) ABSTRACT

A wireless routing circuit is disclosed including: a first RF circuit having a first physical address for communicating with a first set of one or more wireless networking devices each has a gateway address configured as the first physical address; a second RF circuit having a second physical address for communicating with a second set of one or more wireless networking devices each has a gateway address configured as the second physical address; a processing circuit coupled with the first and second RF circuits for processing packets received or to be transmitted by the first and second RF circuits; and a network interface coupled with the processing circuit for communicating with one or more network areas under the control of the processing circuit.

### BACKGROUND OF THE INVENTION

1. Field of the Invention

The present invention relates to wireless network communications, and more particularly, to a wireless network system with enhanced wireless bandwidth and related multi-gateway wireless control circuits.

2. Description of Related Art

Wireless network communication technology makes network applications become more convenient. In many environments, one wireless router (a.k.a. wireless AP) is sufficient for supporting multiple wireless networking devices to access Internet simultaneously.

The wireless networking quality is determined by the performance of the wireless router to a great degree. The conventional wireless router utilizes a single wireless accessing port to simultaneously communicate with multiple wireless networking devices. That is, the conventional wireless router is a single gateway device. However, the bandwidth and performance of the wireless accessing port of the conventional wireless router are limited. When multiple wireless networking devices simultaneously accessing the Internet, the wireless networking quality would be inevitably affected. For example, when some wireless networking devices require consuming huge wireless bandwidth to receive media streaming service, the conventional wireless router has to sacrifice the available bandwidth and network accessing speed of other wireless networking devices so as to maintain the quality of the streaming service. In addition, when some wireless networking devices require downloading large-sized data, it easily causes network flow overload, packet delay, and degrades accessing speed, thereby lowering the performance of the wireless network system.

Network multimedia and real-time applications become more and more popular and therefore an urgent need exists for methods and apparatuses that can improve the wireless network system performance.

### SUMMARY OF THE INVENTION

An exemplary embodiment of a wireless network system is disclosed comprising: a first set of one or more wireless networking devices; a second set of one or more wireless networking devices; and a wireless routing circuit comprising: a first RF circuit having a first physical address for communicating with the first set of one or more wireless networking devices; a second RF circuit having a second physical address for communicating with a second set of one or more wireless networking devices; a processing circuit coupled with the first and second RF circuits for processing packets received by or to be transmitted by the first and second RF circuits; and a network interface coupled with the processing circuit for communicating with one or more network areas under the control of the processing circuit; wherein each of the first set of one or more wireless networking devices has a gateway address configured as the first physical address, and each of the second set of one or more wireless networking devices has a gateway address configured as the second physical address.

One advantage of the above wireless network system is that when a wireless networking device requires consuming huge wireless bandwidth, the available bandwidth and network accessing quality of other wireless networking devices will not be greatly affected.

An exemplary embodiment of a wireless routing circuit is disclosed comprising: a first RF circuit having a first physical address for communicating with a first set of one or more wireless networking devices each having a gateway address configured as the first physical address; a second RF circuit having a second physical address for communicating with a second set of one or more wireless networking devices each having a gateway address configured as the second physical address; a processing circuit coupled with the first and second RF circuits for processing packets received by or to be transmitted by the first and second RF circuits; and a network interface coupled with the processing circuit for communicating with one or more network areas under the control of the processing circuit.

The above wireless routing circuit provides multiple communication gateways by employing multiple RF circuits, and thus has more wireless bandwidth compared to the conventional wireless router, thereby greatly improving the network accessing quality of the wireless local area network.

The above wireless routing circuit needs not consuming considerable computing power to examine the type of the received packets to determine the routing priority of received packets.

An exemplary embodiment of a wireless communication method is disclosed comprising: providing a routing circuit comprising a first RF circuit having a first physical address and a second RF circuit having a second physical address; configuring a gateway address of a first set of one or more wireless networking devices as the first physical address; configuring a gateway address of a second set of one or more wireless networking devices as the second physical address; utilizing the first RF circuit to communicate with the first set of one or more wireless networking devices through wireless transmission; utilizing the second RF circuit to communicate with the second set of one or more wireless networking devices through wireless transmission; and processing packets received by or to be transmitted by the first RF circuit and the second RF circuit using a same processing circuit in the routing circuit.

It is to be understood that both the foregoing general description and the following detailed description are exemplary and explanatory only and are not restrictive of the invention, as claimed.

### BRIEF DESCRIPTION OF THE DRAWINGS

FIG. 1 is a simplified block diagram of a wireless network system in accordance with an exemplary embodiment.

FIG. 2 is a simplified block diagram of the multi-gateway wireless routing circuit of FIG. 1 in accordance with an exemplary embodiment.

FIG. 3 is a simplified block diagram of the multi-gateway wireless routing circuit of FIG. 1 in accordance with another exemplary embodiment.

### DETAILED DESCRIPTION

Reference will now be made in detail to exemplary embodiments of the invention, which are illustrated in the accompanying drawings. The same reference numbers may be used throughout the drawings to refer to the same or like parts or operations.

Certain terms are used throughout the description and following claims to refer to particular components. As one skilled in the art will appreciate, vendors may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ” Also, the phrase “coupled with” is intended to compass any indirect or direct connection. Accordingly, if this document mentioned that a first device is coupled with a second device, it means that the first device may be directly connected to the second device (including through an electrical connection or other signal connections, such as wireless communications or optical communications), or indirectly connected to the second device through an indirect electrical connection or signal connection via other intermediate device or connection means.

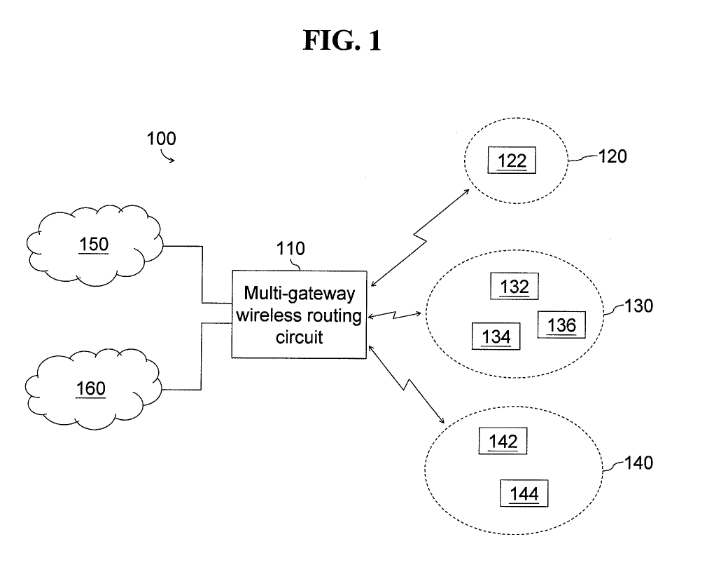

FIG. 1 shows a simplified block diagram of a wireless network system 100 in accordance with an exemplary embodiment. The wireless network system 100 comprises a multi-gateway wireless routing circuit 110 and a plurality of wireless networking devices (e.g., wireless networking devices 122, 132, 134, 136, 142, and 144) within the same local area network. The term “wireless networking device” as used herein is intended to compass any apparatus that is capable of communicating with the multi-gateway wireless routing circuit 110 to access other network sections (e.g. Internet or other network areas), and not intended to be limited in the apparatus dedicated for network accessing. The multi-gateway wireless routing circuit 110 is the communication bridge between a wireless networking device in the wireless network system 100 and network area 150 or 160.

According to the main purpose of network accessing, the wireless networking devices in the wireless network system 100 may be divided into three wireless networking device sets 120, 130, and 140. Each of the wireless networking device sets comprises one or more wireless networking devices which have the same or similar main purposes of network accessing. In this embodiment, the wireless networking device set 120 comprises a wireless networking device 122 whose main purpose of network accessing is to access multimedia streaming service. For example, the wireless networking device 122 may be a set-top box, a computer, a home-use multimedia system or the like for receiving media streaming programs provided by cable TV vendor or ISP. The wireless networking device set 130 comprises three wireless networking devices 132, 134, and 136 whose main purpose of network accessing is to access data. The wireless networking devices 132, 134, and 136 may be computers, smart phones, e-books, game stations, etc. The wireless networking device set 140 comprises two wireless networking devices 142 and 144 whose main purpose of network accessing is to transmit information related to energy consumption. The wireless networking devices 142 and 144 may be refrigerators, air conditioners, electric pots, washing machines, computers, etc.

The above wireless networking device sets 120, 130, and 140 are defined by the main purpose of networking accessing of the wireless networking devices contained therein, not by the main product function, apparatus name, or commercial classification of the wireless networking devices contained therein. Therefore, two devices having the same or similar classification or product function may be divided classified in different wireless networking device sets. For example, both of the wireless networking device 122 of the wireless networking device set 120 and the wireless networking device 132 of the wireless networking device set 130 may be implemented by computers. In addition, the quantity of the wireless networking devices in each wireless networking device set is merely an example, not a restriction of the practical implementations.

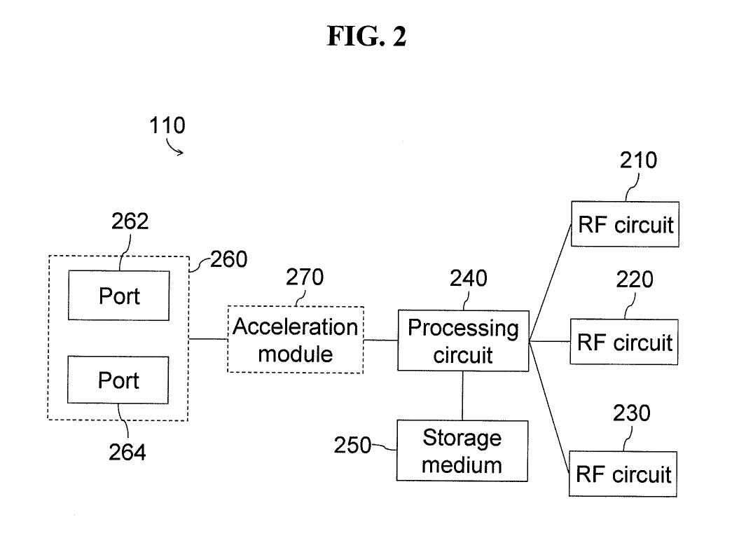

FIG. 2 shows a simplified functional block diagram of the multi-gateway wireless routing circuit 110 according to an exemplary embodiment. As shown, the multi-gateway wireless routing circuit 110 comprises three RF circuits 210, 220, and 230, a processing circuit 240, a storage medium 250, and a network interface 260. The RF circuit 210 has a physical address (such as MAC address) PHY_210, the RF circuit 220 has a physical address PHY_220, and the RF circuit 230 has a physical address PHY_230. Therefore, the RF circuit 210 the RF circuits 210, 220, and 230 of the multi-gateway wireless routing circuit 110 could provide three communication gateways for the wireless networking devices within the local area network. In implementations, the RF circuits 210, 220, and 230 may be implemented with respective wireless network card, or integrated in a single wireless network card. In addition, the RF circuits 210, 220, and 230 may have their respective working frequency bands or use the same working frequency band. The RF circuits that use the same working frequency band may use different channels or adopt different coding schemes to avoid communication interference.

The processing circuit 240 is coupled with the RF circuits 210, 220, and 230 for routing packets received or to be transmitted by the RF circuits 210, 220, and 230. The storage medium 250 is coupled with the processing circuit 240 for storing required routing information for the operations of the processing circuit 240. The network interface 260 is coupled with the processing circuit 240, and communicates with the network areas 150 and 160 under the control of the processing circuit 240. In this embodiment, the network interface 260 comprises a physical connection port 262 connected to the network area 150, and a physical connection port 264 connected to the network area 160. In one embodiment, the network area 150 is corresponding to the Internet and the network area 160 is corresponding to an Intranet. In another embodiment, the network area 150 and the network area 160 are respectively corresponding to different Intranets. In another embodiment, the network area 150 and the network area 160 are both corresponding to the Internet.

In practice, the network interface 260 may be implemented by a switch. In one embodiment, the bandwidth of the network interface 260 is greater than or equal to the total bandwidth of the RF circuits 210, 220, and 230.

In many network environments, such as home-use applications or small business network environments, the system administrator of the wireless network system 100 or the multi-gateway wireless routing circuit 110 is aware of the main purpose of network accessing of respective one of the wireless networking devices 122, 132, 134, 136, 142, and 144. Thus, the system administrator can divide the wireless networking devices 122, 132, 134, 136, 142, and 144 into the three wireless networking device sets 120, 130, and 140 as described above. The system administrator can also configure the gateway address of each wireless networking device in the wireless networking device set 120 as the physical address PHY_210, configure the gateway address of each wireless networking device in the wireless networking device set 130 as the physical address PHY_220, and configure the gateway address of each wireless networking device in the wireless networking device set 140 as the physical address PHY_230.

In operations, the multi-gateway wireless routing circuit 110 utilizes the RF circuit 210 to communicate with the wireless networking device 122 of the wireless networking device set 120 through wireless transmission. Since the main purpose of network accessing of the wireless networking device set 120 is to access media streaming service, the RF circuit 210 may convert multicast packets from the network area 150 and received by the physical connection port 262 of the network interface 260 into unicast packets, and then transmit to the wireless networking device 122 of the wireless networking device set 120 to improve the quality of the media streaming service.

Similarly, the multi-gateway wireless routing circuit 110 utilizes the RF circuit 220 to communicate with the wireless networking devices 132, 134, and 136 of the wireless networking device set 130 through wireless transmission, so that the wireless networking devices 132, 134, and 136 are able to access data from the Internet.

In addition, the multi-gateway wireless routing circuit 110 utilizes the RF circuit 230 to communicate with the wireless networking devices 142 and 144 of the wireless networking device set 140. The wireless networking deviceing 142 and 144 transmit their respective energy consumption related information (such as volume of energy consumption, time distribution of energy usage, frequency of energy usage, etc.) to the multi-gateway wireless routing circuit 110 through wireless transmissions. The processing circuit 240 transmits the energy consumption related information of the wireless networking devices 142 and 144 to an energy consumption information center (such as a dispatch center of the electricity company or the gas company) via the network interface 260. When receives control messages from the energy consumption information center via the network interface 260, the multi-gateway wireless routing circuit 110 transmits the control messages from the energy consumption information center to corresponding wireless networking devices via the RF circuit 230 so as to realize intelligent energy regulation/adjustment function.

In another embodiment, an acceleration module 270 is arranged on the signal input path of the processing circuit 240 (e.g., between the processing circuit 240 and the network interface 260) for processing packets to be inputted into the processing circuit in order to share the computing workload of the processing circuit 240. As a result, the overall performance of the multi-gateway wireless routing circuit 110 can be improved. In implementations, the acceleration module 270 may comprise a VPN accelerator, a security authentication accelerator, an audio/video codec accelerator, or the like.

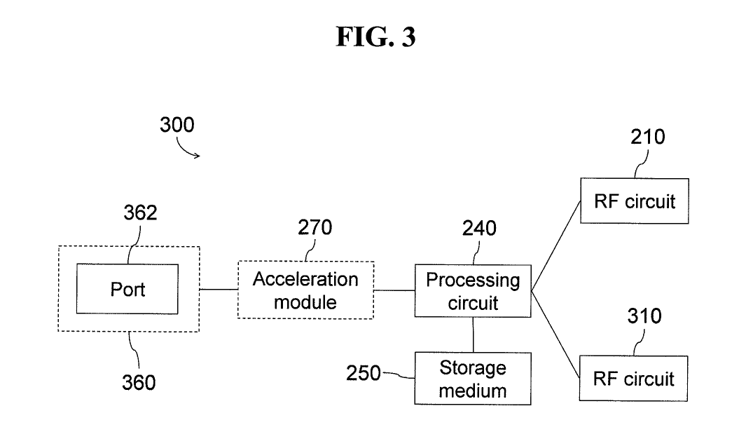

FIG. 3 shows a simplified functional block diagram of a multi-gateway wireless routing circuit 300 according to another exemplary embodiment. In some local area network environments where only a few energy driven devices require intelligent energy regulation/adjustment, or the energy consumption related information needed to be transmitted is not much, the wireless networking device set 140 whose main purpose of network accessing is to transmit energy consumption related information and the wireless networking device set 130 whose main purpose of network accessing is to access data can share the wireless bandwidth of a same RF circuit 310. Thus, one difference between the multi-gateway wireless routing circuit 300 and above multi-gateway wireless routing circuit 110 is that the multi-gateway wireless routing circuit 300 utilizes a single RF circuit 310 to replace the functions of the RF circuits 220 and 230 to reduce the amount of required RF circuits.

Another difference is that a network interface 360 of the multi-gateway wireless routing circuit 300 has only one physical connection port 362 for connecting to a single network area (such as Internet). In other words, the amount of the physical connection ports of the network interface described previously can be adjusted based on the design requirement.

In the foregoing wireless network system 100, the wireless networking device sets 120, 130, and 140 could use their respective communication gateways to access the network and need not to share the wireless bandwidth of the same communication gateway with all other wireless networking devices. As a result, when a wireless networking device requires consuming huge wireless bandwidth of a corresponding communication gateway (such as to access media streaming service or download large-sized data), the available bandwidth and network accessing quality of wireless networking devices of other wireless networking device set will not be greatly affected.

In addition, the above-mentioned wireless routing circuit 110 or 300 could have more wireless bandwidth compared to the conventional wireless routers by employing multiple RF circuits to provide multiple communication gateways, so that the network accessing quality of the wireless local area network can be greatly improved.

From one aspect, each of the wireless networking devices 122, 132, 134, 136, 142, and 144 of the wireless network system 100 has a corresponding default gateway for use to access the Internet. Accordingly, these wireless network devices need not to measure the strength of received signals to dynamically change the communication gateway, and thus their circuitry design can be further simplified. Furthermore, since the multiple wireless network devices in the local area network can be divided into different device sets and each device set is assigned with a default communication gateway, the processing circuit 240 of above multi-gateway wireless routing circuit 110 or 300 needs not consuming considerable computing power to examine the type of the received packets to determine the routing priority of received packets.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A wireless network system comprising:
a first set of one or more wireless networking devices;
a second set of one or more wireless networking devices; and
a wireless routing circuit comprising:
a first RF circuit having a first physical address for communicating with the first set of one or more wireless networking devices;
a second RF circuit having a second physical address for communicating with a second set of one or more wireless networking devices;
a processing circuit coupled with the first and second RF circuits for processing packets received by or to be transmitted by the first and second RF circuits; and
a network interface coupled with the processing circuit for communicating with one or more network areas under the control of the processing circuit;
wherein each of the first set of one or more wireless networking devices has a gateway address configured as the first physical address, and each of the second set of one or more wireless networking devices has a gateway address configured as the second physical address.

2. The wireless network system of claim 1, wherein the first RF circuit and the second RF circuit have the same working frequency band.

3. The wireless network system of claim 1, further comprising:
one or more energy driven devices for transmitting their respective energy consumption related information to the wireless routing circuit through wireless transmission;
wherein the processing circuit transmits the energy consumption related information of the one or more energy driven devices to an energy consumption information center via the network interface.

4. The wireless network system of claim 3, wherein the wireless routing circuit receives the energy consumption related information of the one or more energy driven devices by utilizing the first RF circuit or a third RF circuit.

5. A wireless routing circuit comprising:
a first RF circuit having a first physical address for communicating with a first set of one or more wireless networking devices each having a gateway address configured as the first physical address;
a second RF circuit having a second physical address for communicating with a second set of one or more wireless networking devices each having a gateway address configured as the second physical address;
a processing circuit coupled with the first and second RF circuits for processing packets received by or to be transmitted by the first and second RF circuits; and
a network interface coupled with the processing circuit for communicating with one or more network areas under the control of the processing circuit.

6. The wireless routing circuit of claim 5, wherein the first RF circuit and the second RF circuit have the same working frequency band.

7. The wireless routing circuit of claim 5, wherein the wireless routing circuit further receives energy consumption related information of one or more energy driven devices by utilizing the first RF circuit or a third RF circuit, and the processing circuit transmits the energy consumption related information of the one or more energy driven devices to an energy consumption information center via the network interface.

8. The wireless routing circuit of claim 5, further comprising:
an acceleration module arranged on a signal input path of the processing circuit for processing packets to be inputted into the processing circuit.

9. The wireless routing circuit of claim 5, wherein the network interface comprises:
a first physical connection port for communicating with a first network area; and
a second physical connection port for communicating with a second network area.

10. The wireless routing circuit of claim 5, wherein the first RF circuit converts multicast packets received by the network interface from a network area into unicast packets, and transmits the unicast packets to a corresponding wireless networking device.

11. A wireless communication method comprising:
providing a routing circuit comprising a first RF circuit having a first physical address and a second RF circuit having a second physical address;
configuring a gateway address of a first set of one or more wireless networking devices as the first physical address;
configuring a gateway address of a second set of one or more wireless networking devices as the second physical address;
utilizing the first RF circuit to communicate with the first set of one or more wireless networking devices through wireless transmission;
utilizing the second RF circuit to communicate with the second set of one or more wireless networking devices through wireless transmission; and
processing packets received or to be transmitted by the first RF circuit and the second RF circuit using a same processing circuit in the routing circuit.

12. The wireless communication method of claim 11, wherein the first RF circuit and the second RF circuit have the same working frequency band.

13. The wireless communication method of claim 11, further comprising:
utilizing the first RF circuit to receive energy consumption related information of one or more energy driven devices; and
transmitting the energy consumption related information of the one or more energy driven devices to an energy consumption information center.

14. The wireless communication method of claim 13, further comprising:
receiving control information from the energy consumption information center; and
utilizing the first RF circuit to transmit the control information to a corresponding energy driven devices.

15. The wireless communication method of claim 11, further comprising:
utilizing a third RF circuit to receive energy consumption related information of one or more energy driven devices; and
transmitting the energy consumption related information of the one or more energy driven devices to an energy consumption information center.

16. The wireless communication method of claim 15, further comprising:
receiving control information from the energy consumption information center; and
utilizing the third RF circuit to transmit the control information to a corresponding energy driven devices.

17. The wireless communication method of claim 11, further comprising:
receiving multicast packets from a network area; and
converting the multicast packets into unicast packets; and
utilizing the first RF circuit to transmit the unicast packets to a corresponding wireless networking device.
